(19) United States
(12) Patent Application Publication
(10) Pub. No.: US 2013/0217387 A1
(43) Pub. Date: Aug. 22, 2013

(54) PROXIMITY-BASED ONLINE COMMUNICATION SYSTEM

(71) Applicant: Steven Lin Pfirman, Jupiter, FL (US)

(72) Inventor: Steven Lin Pfirman, Jupiter, FL (US)

(21) Appl. No.: 13/400,116

(22) Filed: Feb. 20, 2012

(51) Int. Cl. H04W 4/02; H04W 60/00

(52) U.S. Cl. 455/435.1; 455/456.6

(57) ABSTRACT

Disclosed is a proximity-based online communication system comprising a plurality of GPS-enabled remote terminals registered therewith enabling the remote terminals to communicate with one another over at least one communication network when logged thereinto, a GPS module in communication with the GPS component of each remote terminal so as to receive the current geographic location of each remote terminal, the GPS module comprising a GPS database comprising the information of the distances between any two geographical locations, and a processor for enabling a remote terminal to limit the communication thereof to the fellow remote terminals that are within a degree of proximity therefrom wherein, the degree of proximity is set by the user of the remote terminal that initiates the communication and wherein, the fellow remote terminals that are within the degree of proximity are identified by the GPS module.

### BACKGROUND

The present invention relates to online communication systems and more particularly to an online system that helps a user to limit the communication thereof to the fellow users that are within a degree of proximity from the user wherein, the degree of proximity is set based on the discretion of the user.

The typical virtual communities or forums that exist on the Internet today allow netizens, i.e., the users of the internet, to join and participate therein from anywhere in the world. Usually, these communities are divided into various categories, each of which, in turn, is further divided into various subcategories so that users may participate in a sub-community that is relevant or of interest to them. By way of example, a community category that reads “sports & recreation” can further be divided into various subcategories viz., “baseball”, “soccer”, “hiking”, and etc. Likewise, there are also community categories and subcategories that are based on various regions or places. However, these online community categories (and subcategories), even though are dedicated to specific geographical areas, they can be, as mentioned earlier, accessed by anybody from anywhere in the world and there is no way to know whether or not the users participating in a community category that is dedicated to a specific geographical area are genuinely from that specific geographical area. One reason for the necessity to know the geographic area of the users participating in the community is to ensure the information shared during the communication between the users is relevant. Another reason would be to help make the virtual community more local and thereby more personalized to the users participating therein. In the light of the above discussion, there is a need in the art for such an online community or communication system that fulfils the aforementioned shortcomings of typical present day online communities.

### SUMMARY

The present invention comprises a proximity-based online communication system for enabling a GPS-enabled remote terminal to limit the communication thereof to fellow remote terminals that are within a degree of proximity therefrom. The online communication system employs a GPS module adapted to be in constant communication with the GPS component of each remote terminal so as to receive the current geographical location thereof. The online communication system enables the user of a remote terminal to set or input a degree of proximity before dispatching communication content created or composed by him/her. Once the degree of proximity is set by the user, the communication content is dispatched to the fellow remote terminals that are within the degree of proximity wherein, the fellow remote terminals that are within the degree of proximity are identified by the GPS module.

The objects and advantages of the embodiments herein will become readily apparent from the following detailed description taken in conjunction with the accompanying drawings.

### BRIEF DESCRIPTIONS OF THE DRAWINGS

FIG. 1 is a block diagram of the proximity-based online communication system.

FIG. 2 is a flowchart depicting method of the proximity-based online communication system.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

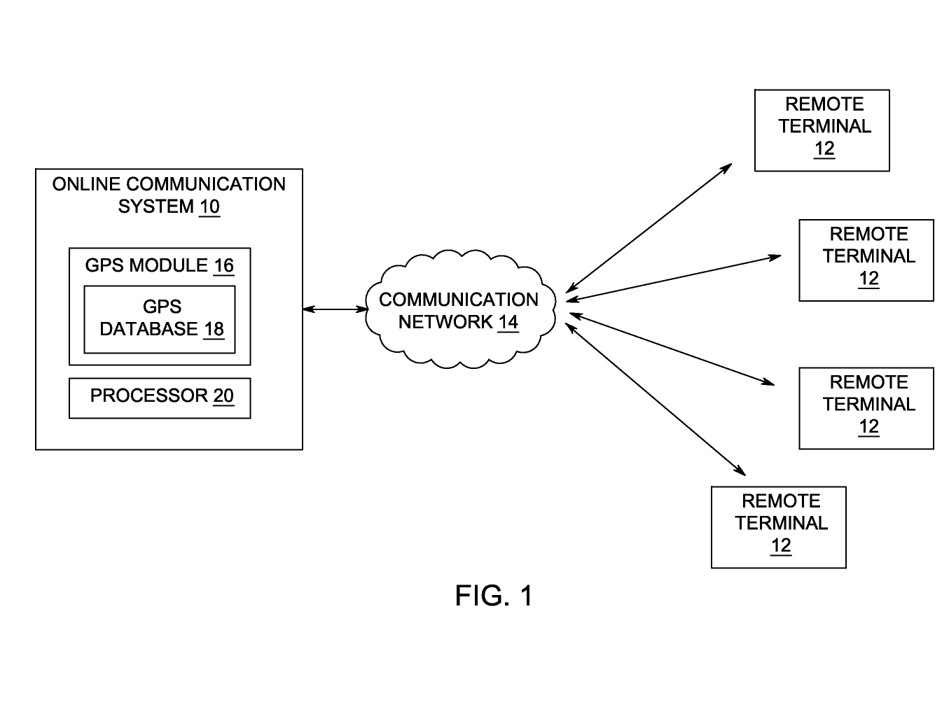

Referring to FIG. 1, the present invention comprises a proximity-based online communication system 10 for enabling a client-side Global Positioning System (GPS)-enabled remote terminal 12 registered therewith to not only communicate with fellow registered client-side GPS-enabled remote terminals 12, but to limit the communication thereof to the fellow remote terminals 12 that are within a degree of proximity from the remote terminal 12. The degree of proximity comprises a distance measurement value and is to be set or input by the user of the remote terminal 12 that initiates the communication. For example, when the user sets the degree of proximity to, for example, 10 miles, then, only the fellow remote terminals 12 within a 10 mile radius of the user are receptive to the communication from the user. The remote terminals 12 comprise wireless portable devices such as cellular phones, tablets, notebooks, laptops, and the like. The types of communication or interaction facilitated by the online communication system 10 between the remote terminals 12 could be a voice-call, video-call, texting, sharing of multimedia content such as pictures, videos, and etc, wherein these types of communication are well known in the art. The remote terminals 12 communicate over a communication network 14, such as a radio or cellular network, or the Internet, or a combination thereof. Preferably, the online communication system 10 employs packet switched IP network, such as Voice over Internet Protocol (VoIP).

Again referring to FIG. 1, the online communication system 10 further comprises a user interface (not shown) for enabling the users of the remote terminals 12 to interact therewith, and thereby with themselves, a GPS module 16, which is in constant communication with each of the GPS components of the remote terminals 12 so as to receive the information of the current geographical location (hereinafter, “geo-location”) of each remote terminal. The user interface may either comprise a website or a VoIP client application such as Google Talk™ or Yahoo Messenger™, where a user has to log into the online communication system 10 in order to avail the services thereof. The GPS module 16 comprises a GPS database 18 comprising the information of the distances between any two geographical locations. The online communication system 10 further comprises a processor 20, which actually enables a remote terminal 12 to communicate with fellow remote terminals 12 based on the degree of the proximity. More particularly, the processor 20 is configured such that the communication content, such as a voice mail, video mail, or a text message, dispatched from a remote terminal 12 is only received by the fellow remote terminals 12 that are within a degree of proximity wherein, the fellow remote terminals 12 that are to receive the communication content are identified by the GPS module 16.

Still referring to FIG. 1, in order to avail the services of the online communication system 10, a user may have to sign up or register for the same by providing registration details thereof. Once the user has registered, he/she can then log into the online communication system 10 by entering the login or sign in details that are validated in the earlier registration process. Once logged in, the user can interact with fellow users through the remote terminals 12 in a variety of ways as mentioned earlier. The GPS module 16 is always in communication with the GPS component of the user's remote device 12 throughout the user's participation in the online communication system 10 thereby keeping track of the user's current geo-location.

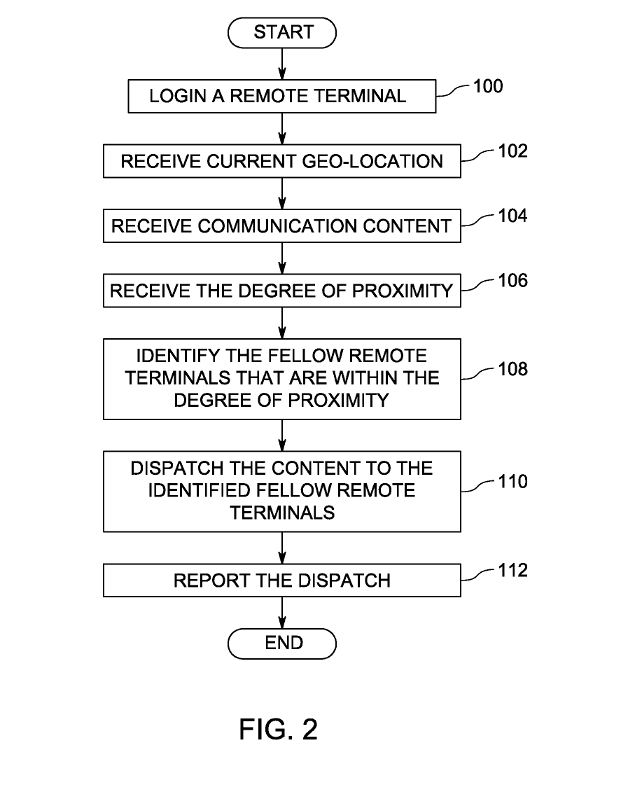

Referring to FIG. 2, the flowchart depicts the method employed by the online communication system of the present invention. The method begins at step 100 with a user logging into the online communication system by providing login details thereof. Upon validation of the login details, the user is logged into the online communication system whereby, the user can participate therein by interacting or communicating with the fellow users through remote terminals thereof. One the user is logged in, the GPS component of the user' remote terminal communicates the current geo-location of the user to the GPS module as seen in step 102. At step 104, the online communication system receives the communication content composed or created by the user. Along with the communication content, a degree of proximity is set by the user as seen in step 106. Once the degree of proximity is input by the user, the processor, as seen in step 108, proceeds to identify the fellow users that are within the degree of proximity as enabled by the GPS module. At step 110, the communication content is transmitted to the identified fellow users. Finally, a dispatch report comprising the information of fellow user or users to who the communication content is dispatched is sent to the user as seen in step 112. The fellow user or users to who the communication content interests may choose to communicate back to the user.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. For example, the mobile phones can be replaced with other suitable devices such as tablets, laptops, and so on. In another example, the radio network can be replaced with the Internet. However, all such modifications are deemed to be within the scope of the claims.

It is also to be understood that the following claims are intended to cover all of the generic and specific features of the embodiments described herein and all the statements of the scope of the embodiments which as a matter of language might be said to fall therebetween.

What is claimed is:

1. A proximity-based online communication system comprising:
(a) a plurality of GPS-enabled remote terminals registered therewith enabling the remote terminals to communicate with one another over at least one communication network when logged thereinto;
(b) a GPS module in communication with the GPS component of each remote terminal so as to receive the current geographic location of each remote terminal, the GPS module comprising a GPS database, which comprises the information of the distances between any two geographical locations; and
(c) a processor for enabling a remote terminal to limit the communication thereof to the fellow remote terminals that are within a degree of proximity therefrom;
wherein, the degree of proximity is set by the user of the remote terminal that initiates the communication and wherein, the fellow remote terminals that are within the degree of proximity are identified by the GPS module.

2. The online system of claim 1 wherein, each remote terminal comprises a wireless portable device.

3. The online system of claim 1 wherein, the degree of proximity comprises a distance measurement value.

4. The online system of claim 1 wherein, the at least one communication network comprises two communication networks, viz., radio network and the Internet.

5. A proximity-based online communication system comprising:
(a) a plurality of GPS-enabled wireless portable devices registered therewith enabling the wireless devices to communicate with one another over at least one communication network when logged thereinto;
(b) a GPS module in communication with the GPS component of each wireless device so as to receive the current geographic location of each wireless device, the GPS module comprising a GPS database, which comprises the information of the distances between any two geographical locations; and
(c) a processor for enabling a wireless device to limit the communication thereof to the fellow wireless devices that are within a degree of proximity therefrom;
wherein, the degree of proximity is input by the user of the wireless device that initiates the communication and wherein, the fellow wireless devices that are within the degree of proximity are identified by the GPS module.

6. A method for enabling a GPS-enabled remote terminal to limit the communication thereof to fellow GPS-enabled remote terminals that are within a degree of proximity therefrom, the degree of proximity set by the user of the remote terminal that initiates the communication, the method comprising:
(a) registering the remote terminals with a proximity-based online communication system so as to enable the remote terminals to communicate with each other over at least one communication network when logged thereinto;
(b) establishing a communication between a GPS module and the GPS components of the remote terminals such that the current geographical location of each remote terminal is received within the GPS module, the GPS module comprising a GPS database comprising the information of distances between any two geographical locations;
(c) receiving communication content composed by the user, the communication content to be communicated to the fellow remote terminals;
(d) receiving the value of the distance set by the user;
(e) identifying the remote terminals that are within the distance, the remote terminals identified by the GPS module; and
(f) delivering the communication content to the identified remote terminals.

7. The method of claim 6 wherein, each remote terminal comprises a wireless portable device.

8. The method of claim 6 wherein, the degree of proximity comprises a distance measurement value.

9. The method of claim 6 wherein, the at least one communication network comprises two communication networks, viz., radio network and the Internet.

10. The method of claim 6 wherein, the GPS module is disposed with the online system.

11. A method for enabling a GPS-enabled wireless portable device to limit the communication thereof to fellow GPS-enabled wireless handheld devices that are within a degree of proximity therefrom, the degree of proximity set by the user of the wireless device that initiates the communication, the method comprising:
(a) registering the wireless devices with an online communication system so as to enable the wireless devices to communicate with each other over at least one communication network when logged thereinto;
(b) establishing a communication between a GPS module and the GPS components of the wireless devices such that the current geographical location of each wireless device is received within the GPS module, the GPS module comprising a GPS database comprising the information of distances between any two geographical locations;
(c) receiving communication content composed by the user, the communication content to be communicated to the fellow wireless devices;
(d) receiving the value of the distance set by the user;
(e) identifying the wireless devices that are within the distance, the wireless devices identified by the GPS module; and
(f) delivering the communication content to the identified wireless devices.
